(19) United States
(12) Patent Application Publication
(10) Pub. No.: US 2009/0171775 A1
(43) Pub. Date: Jul. 2, 2009

(54) PROMOTIONAL INCENTIVE VOUCHER AND METHOD FOR PROVIDING A SELECTABLE GIFT CARD TO A RECIPIENT

(75) Inventors: James T. Cashion, Jr., Lake Worth, FL (US); Jeff Hansel, Lake Worth, FL (US)

Correspondence Address: CAREY, RODRIGUEZ, GREENBERG & PAUL LLP;ATTN: STEVEN M. GREENBERG, ESQ., 950 PENINSULA CORPORATE CIRCLE, SUITE 3020, BOCA RATON, FL, 33487, US

(73) Assignee: CUSTOMER MOTIVATORS, LLC, Lantana, FL (US)

(21) Appl. No.: 11/964,829

(22) Filed: Dec. 27, 2007

(51) Int. Cl. G06Q 30/00

(52) U.S. Cl. 705/14

(57) ABSTRACT

A promotional incentive voucher and method for providing a selectable gift card (stored value card or SVC) as a gift to a recipient. The incentive voucher includes an advertising portion comprising information that identifies a business that is providing the voucher and SVC as a gift to a recipient of the voucher; a gift display portion listing a plurality of SVCs available for selection by the recipient; and a gift redemption portion for use by the recipient to selected a desired SVD from the listing and to direct delivery of the gift to the recipient. A method for producing a promotional incentive voucher of the invention includes obtaining from a business desired advertising and SVC gift selection information to be included in the promotional incentive voucher, and producing a voucher comprising the desired information and a gift redemption portion for enabling the recipient to obtain the selected SVC gift.

### TECHNICAL FIELD

The present invention relates to gift vouchers that are used for promotional purposes by businesses, e.g., to generate goodwill, express gratitude to existing customers, attract new customers, or otherwise motivate or promote the success of a business.

### BACKGROUND

In recent years the world of commerce has become increasingly impersonal and business is conducted at an unprecedented pace, largely due to the spawning of internet commerce and global manufacturing capabilities. Businesses are now faced with competition not just around the corner, but from all corners of the globe and cyberspace. As a result of the intensely competitive environment, businesses that provide either goods or services to consumers have increasingly become aware of the need to promote their products through advertising.

It has also been long recognized that a competitive business advantage may be gained not just by advertising, but also by giving gifts or tokens of appreciation that create goodwill, e.g., with potential customers who express an interest in a provider's goods or services, or reward and encourage the loyalty of existing customers. To address the ongoing need for corporate gifts, numerous gifting options have become available over the years. Traditionally, and most typically at annual holidays, businesses have provided their best clients with gifts such as fruitcakes, fruit baskets, various other holiday foodstuffs, liquors or other alcoholic or non-alcoholic beverages, floral arrangements, chocolates, candies, and the like. Typically, such gifts are delivered to the customer/recipient along with an appropriate mass-produced greeting card or gift enclosure card that is signed by a member of the donor business such as the business owner, or an employee or associate responsible for marketing or outreach to customers or accounts of the business. In some cases, the gift is delivered along with a custom-printed card that identifies the corporate donor.

Recent years have seen a proliferation of gift-oriented stores that offer an ever-growing range of products to both private individuals and corporate buyers. At first, these products were provided mainly through mail order catalogues but more recently have become widely available online. At the same time, the number of gift-giving occasions during the year has escalated dramatically.

Accompanying this growth in the gift industry is a relatively recent gift-giving innovation known as a “gift card,” or “stored value card” (“SVC”). Stored value cards are typically made of plastic or stiff paper card and resemble a wallet-sized credit/debit card or bank access (ATM) card. SVCs in various denominations may be purchased from many retail stores and other vendors. The cards are loaded with a predetermined machine-readable monetary value which may be used in a selected store by the recipient of the card. Gift cards of various types are redeemable for merchandise or services at retail stores such as coffee shops, bookstores, department stores, sporting goods stores, and so on.

Gift cards are desirable as a gifting option because they can provide a convenient alternative to giving cash or a check to a recipient, and like cash can allow the recipient to choose his or her own gift from among the items offered by the particular retail outlet honoring the card. Additional advantages of SVCs are that they do not require gift wrapping. Further, being light and compact, SVCs are inexpensive to transport or ship to a recipient.

As discussed above, corporate gift-giving (gift-giving to a potential or existing customer or client on behalf of a business) is recognized as an effective business promotion method, both for rewarding loyalty and stimulating business from existing customers and for attracting new business. A stored value card as a choice for a corporate gift can provide the above-stated advantages over other forms of gifts. On the other hand, the effectiveness of a gift card as a tool for promoting a business may be diminished if the particular card is only redeemable at a pre-selected retail outlet or service provider that is ill-matched to the buying habits and preferences of the gift card recipient. In the worst case, the SVC, if inappropriately matched to the recipient, may be completely unappreciated, and even discarded, defeating its purpose as a business stimulator.

Particularly in the business world, a buyer of corporate gifts is unlikely to have detailed knowledge of the particular buying habits or preferences of a targeted recipient. Accordingly, there is a need for a more effective method of providing SVCs as promotional business tools that will be appreciated and used by their recipients, thereby increasing the goodwill of the donor's business in the eyes of the recipient, and justifying the expense of the SVC in the marketing budget of the corporate donor.

### SUMMARY OF THE INVENTION

The invention provides a novel solution to address the needs of corporate promotional gift-givers, by making available a promotional incentive voucher and method for providing as a gift to a recipient a choice of stored value card from among a selection of SVCs. The promotional incentive voucher comprises several components including marketing features such as an advertising portion that prominently identifies and advertises the business that is providing the voucher and gift to a recipient of the voucher. Also included in the incentive voucher is a gift display portion that lists a variety of selectable SVC choices from various outlets, any one of which is available as a gift selection to a recipient of the incentive voucher.

An innovative feature that adds significant flexibility to the gift is the availability of the choice of an SVC from among a plurality of SVCs offered to the recipient. Advantageously, this feature greatly increases the likelihood that the gift voucher will be valued by the recipient.

For delivery of the gift SVC to the recipient, promotional incentive vouchers of the invention also include a gift redemption portion for use by the recipient to indicate a selected SVD from among those listed, and to provide the recipient's delivery information.

In some embodiments of promotional incentive vouchers in accordance with the invention, the advertising portion of the incentive voucher includes text or graphics such as logos or trademarks that identify the business to the recipient.

Preferably, the advertising portion is displayed on the outside of the incentive voucher when first viewed by the recipient. The advertising portion can further comprise an expression of gratitude for using the goods or services of the business, or a wish that the recipient will enjoy the gift provided by the business to the recipient of the promotional incentive voucher.

In some embodiments of promotional incentive vouchers of the invention, the gift display portion of the card includes a listing of a plurality of SVCs, each of which is useable to pay for goods or services at a different retail store or service provider.

In some versions of the promotional incentive vouchers, the gift redemption portion comprises a detachable card with instructions to the recipient to redeem the gift by entering the gift selection and delivery information on the card. The completed card is detached and mailed to an indicated address of a provider of the selected gift. In preferred embodiments of these cards, postage is prepaid on the mail-in gift redemption portion of the incentive voucher.

In other embodiments of the promotional incentive vouchers, the gift redemption portion comprises instructions to the recipient to redeem the gift by entering the gift selection and delivery information at a website on the internet.

Some preferred embodiments of the promotional incentive vouchers in accordance with the invention are foldable into two, three, or more parts. Preferably, to maximize the advertising value and to sustain the interest and curiosity of the recipient, the incentive vouchers are designed, upon being folded, with the advertising portion facing outward and the gift display portion and the gift redemption portion positioned on the inside of the card.

A promotional incentive voucher of the invention can further comprise an envelope proportioned to contain the card when folded. Alternatively, a folded card can be held in the closed position by a fastener such as a circular piece of transparent adhesive tape or similar fastener.

Another aspect of the invention is a method for producing a promotional incentive voucher for providing a selectable stored value card (SVC) as a gift to a recipient (such as a current, former, or prospective client of a business). The method includes the steps of obtaining from an owner or representative of a business the details of advertising information that is desired to be included in an advertising portion of the promotional incentive voucher. Also obtained from the business person is desired gift selection information including a listing of SVC choices to be printed on the gift display portion of the promotional incentive voucher. To further enhance the likely appeal of the gift to the recipient, the selection of SVCs that the business chooses to make available on its promotional incentive voucher can be tailored to fit the demographic of the company's desired customers or business targets.

The inventive method further includes the step of manufacturing a promotional incentive voucher that includes the advertising and gift selection information desired by the business, as well as a gift redemption portion providing instructions to the recipient for obtaining the selected gift.

In some embodiments of the method, the gift redemption portion of the promotional incentive voucher is produced with instructions to the recipient to complete and mail a detachable gift redemption portion of the incentive voucher, in order to request delivery of the selected SVC from an order processing center. In other embodiments of the method, the incentive voucher is produced with instructions to the recipient to initiate the redemption process by entering information at a website on the internet.

The method for producing a promotional incentive voucher for providing a selectable SVC as a gift to a recipient can further comprise a step of the internally fulfilling the orders for the selected SVC, in which case the method comprises an all-in-one method of serving the promotional needs of business owners by providing a service for creating a customized promotional incentive voucher for providing a selectable SVC as a business gift, as well as a service for fulfilling the redeemed gift orders from the recipients of the promotional incentive vouchers.

The inventive promotional incentive vouchers and their method of manufacture have a broad range of applications and uses, and are expected to be effective as business promotion tools for a wide range of business types, particularly those associated with “big ticket” spending decisions by clients or customers. Industries that could benefit from providing the promotional incentive vouchers of the invention to their customers could include, e.g., financial institutions, insurance companies, automobile or marine manufacturers or dealerships, furniture retailers, electronics and telecommunications equipment retailers and service providers, utilities providers, hospitals and health services providers, airlines, rail lines and other transportation providers, residential or commercial builders, professional service providers (architects, accountants, lawyers, etc.) and educational institutions hoping to attract or retain top students.

Other aspects and advantages of the invention are discussed below.

### BRIEF DESCRIPTION OF THE DRAWINGS

FIG. 1 is perspective view of a partially unfolded promotional incentive voucher for providing a selectable gift card 100 having a tri-fold configuration, in accordance with an embodiment of the present invention.

FIG. 2 is a diagrammatic illustration depicting features appearing on the front surfaces of the tri-fold promotional incentive voucher 100 shown in FIG. 1, as viewed in its unfolded state. Features include a printed gift display portion (105, 110) and a gift redemption portion (115) in the form of a detachable card.

### DETAILED DESCRIPTION OF THE INVENTION

The present invention provides an innovative and effective solution for corporate gift-giving by providing to businesses and their representative a new marketing and business promotion tool that may be considered to be a customized and personalized “gift card within a gift card,” or more precisely, a “selectable gift card (or stored value card, SVC) within a promotional incentive voucher.”

### Promotional Incentive Voucher for Providing a Selectable Gift Card

In one aspect, the invention provides a promotional incentive voucher for providing a selectable stored value card (SVC) as a gift to a recipient. Several aspects of promotional incentive vouchers in accordance with the invention are referred to herein for simplicity as “portions,” although it is to be understood that these portions or elements may be physically combined or overlapping, for example, on a single sheet of paper.

An exemplary promotional incentive voucher of the invention comprises:

(a) an advertising portion comprising information that identifies the business that is providing the incentive voucher to a recipient of the card;

(b) a gift display portion comprising a listing of a plurality of SVCs available for selection by a recipient of the incentive voucher; and

(c) a gift redemption portion for use by the recipient to select a desired SVC from the listing.

As used herein, the term “promotional” is meant to include any item or activity that is used to promote, improve, or enhance the awareness, recognition, or goodwill towards a business, in the mind of a customer or client of the business (either present, former or prospective).

The term “business,” as it is used herein, is meant to refer to any form of commercial enterprise or entity of any kind. The term “corporate,” as in “corporate gift-giving” or “corporate donor” is not meant to be interpreted as limited to incorporated forms of businesses, but rather is meant to include all forms of business including sole proprietorships. Similarly, a “corporate donor” may be any individual or any form of business entity or representative thereof associated with giving, or directing the delivery of, a promotional gift, such as a incentive voucher of the invention, to a recipient.

A “greeting card” as the term is used herein, is a card, typically but not necessarily made of paper, having one or more sections that may fold upon themselves, that includes a sentiment, or expression of emotion, such as an expression of gratitude, congratulations, encouragement, annual salutations, and so on. The expressed emotion reflected by the card is intended to be conveyed by means of the card to its recipient by the donor/sender of the card. Selecting and sending commercially-produced greeting cards is a well known and time-honored social practice for expressing emotions in written form. In a commercial gift-giving setting, a “corporate greeting card,” as the term is used herein, is typically a mass-produced greeting card, in some cases imprinted with the name of the corporate donor, obviating the need for a signature.

A “promotional incentive voucher,” as the term is used herein, in contrast to a corporate greeting card, refers to a custom-printed card or sheet in any format that is used for business purposes, and includes an “advertising portion;” a “gift selection portion;” and a “gift redemption portion.” The advertising portion serves to alert the recipient of the identity of the corporation, business, or business representative responsible for sending the voucher. The advertising portion may comprise a message in text (such as the company name), a graphical image, a logo, a trademark, or other form of branding, or any combination of such elements, that promotes recognition and awareness of the company and serves to identity the corporate donor to the recipient or other viewer of the voucher.

In promotional incentive vouchers in accordance with the invention, the identity of the corporate donor in the advertising portion may be displayed at any position or on any portion of the promotional incentive voucher. Some preferred embodiments of promotional incentive vouchers of the invention are configured as a doubly-,triply-, or multiply-folded sheet in which an advertising portion is prominently displayed on an outward-facing surface of the sheet when the sheet is folded, making the identity of the corporate donor apparent to the recipient even when the voucher is viewed in the closed (folded) position.

A promotional incentive voucher in accordance with the invention, in addition to serving as an advertisement that identifies the corporate donor, may also include an appropriate greeting, sentiment or expression that the corporate donor wishes to convey to the recipient. In the context of business gifts or rewards for customer loyalty and the like, the sentiment most likely is one of gratitude, although the invention is not so limited.

One non-limiting example of a use of a promotional incentive voucher in accordance with the invention is in the context of the financial industry. For example, a financial institution may desire to reward its new customers who have recently opened an account with the institution. In this case, a customized promotional incentive voucher of the invention could be created that might display an advertising portion identifying the financial institution. The advertising portion could further include an expression of gratitude, such as “Welcome to OURBANK. We're proud to serve you, and here is our way of SAYING THANKS . . . . ” It will be immediately apparent that vouchers of the invention can be customized to suit the needs of many other types of businesses.

As will be apparent from the foregoing, an important advantage of promotional incentive vouchers in accordance with the present invention is the fact that the vouchers can be custom-made to suit the needs and client demographic of the corporate donor. Key features of the promotional incentive vouchers, including the advertising portion, the sentiment expressed by the card, and the plurality of gift card choices available for selection by the recipient (further described below) can be customized to suit the needs and promotional goals of the corporate donor.

As further described below, promotional incentive vouchers of the invention can be created by a method that permits the corporate donor to personalize the card for its intended recipients. Accordingly, a promotional incentive voucher can be designed to be a custom fit for the demographic of the intended recipient, offering as a gift a SVC that may be selected from a plurality of SVCs. Thus, in view of the built-in flexibility in the choice of gift, the promotional incentive voucher and the gift it offers is more likely to have a favorable impact on the recipient than a single gift offering having no flexibility or options. It is believed that the availability of such choice is likely to be appreciated by recipients, resulting in increased goodwill for the business and promotion of further business dealings, referrals of other customers to the business, etc.

It is clear from the foregoing that unlike conventional advertising alone, or conventional corporate greeting cards alone, promotional incentive vouchers in accordance with the invention serve a multitude of business purposes including: 1) advertising a business to recipients of the card such as a new or existing client or customer, or a former or prospective client, etc.; 2) providing an expression of gratitude or other sentiment as appropriate from the business owner or representative for past, present or desired patronage of the business by the client; and, 3) importantly, providing a business motivator (a gift) to the recipient in the form of a SVC that may be selected by the recipient from among a plurality of SVCs displayed on the gift display portion of the incentive voucher.

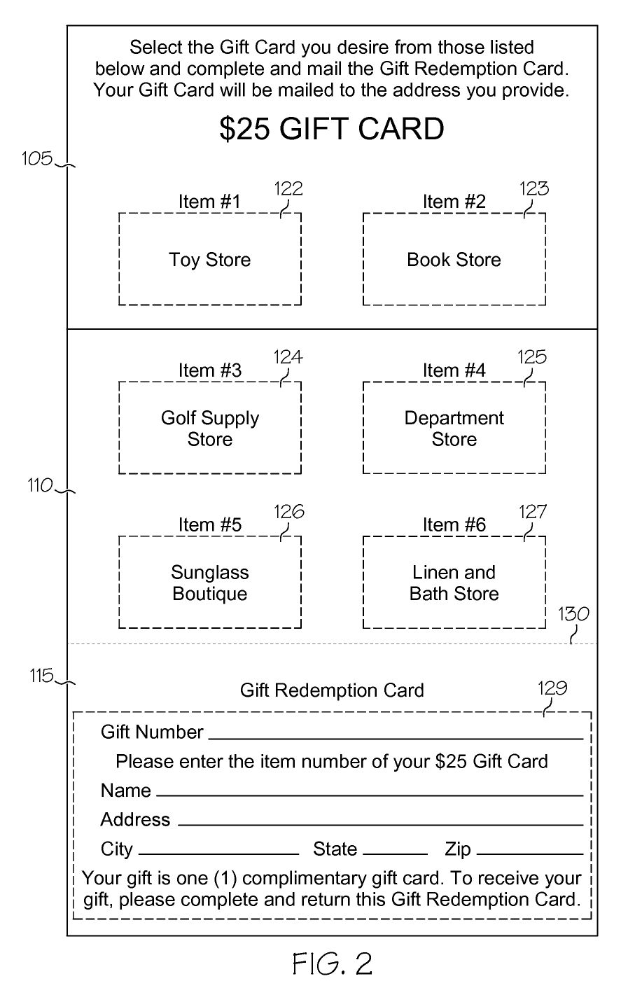

As mentioned above, promotional incentive vouchers in accordance with the invention include a gift display portion that includes a listing of a plurality of stored value cards available for selection by a recipient of the voucher. As described, the business representative, when ordering the production of a customized promotional incentive voucher, can choose the selection of SVCs to be displayed on the gift display portion of the incentive voucher from a large number of choices that can be provided by a producer of the customized promotional incentive vouchers. Any number of SVC selections (ranging from 2 to 50 or more) can be chosen and displayed in a variety of layouts and printing options. In one particular embodiment, shown in FIG. 2, the incentive voucher lists a selection of six gift cards, but the invention is not so limited.

To maximize the appeal of the gift to the customer (and hence to obtain the most value for the marketing dollar spent on the promotional incentive vouchers), the business representative can select the SVCs to be displayed on the card according to his or her perception or knowledge of the needs or desires of the clients/customers of the business. For example, a hair salon hoping to promote and increase its business might choose to incentivize repeat business from new female clients by sending them a promotional incentive voucher that advertises the salon business on the front of the card, acknowledges and thanks the clients for their recent patronage of the business, and offers the recipients a choice of SVC from among a list of selected retailers that specialize in hair and beauty products, or other products or services (such as massage, aromatherapy, hotel or day spa, etc.) that are perceived to be likely to appeal to women in the demographic of the clients of the salon.

In one particularly preferred embodiment of the promotional incentive voucher, the gift that is included is a SVC having a fixed monetary value, e.g., $25, $50, and so on. Accordingly, a recipient of this type of promotional incentive voucher is invited to choose, e.g., a $50 gift card (SVC) for use at one of a plurality of retail stores or service providers listed on the card.

The choices of SVCs available for selection can be represented in any suitable manner on the gift selection portion of the incentive voucher. For example, the gift choices may be identified by using a consumer-recognizable logo or branding of a selected company, with or without text providing a brief description of the goods or services provided by that company. In some embodiments of the incentive vouchers, a “gift number” is associated with each choice on the gift display portion, for the purpose of conveniently identifying a particular gift as the recipient's choice on the gift redemption portion of the incentive voucher.

Promotional incentive vouchers in accordance with the invention further include a gift redemption portion for use by the recipient to select a desired gift card and in some embodiments, to provide information required for delivery of the gift. Alternatively, the gift redemption portion of the incentive voucher can include instructions to the recipient to redeem the chosen gift by logging on to a website on the internet and providing gift selection and delivery information online, in order to facilitate delivery of the gift by a supplier.

In another embodiment of the promotional incentive voucher, the gift redemption portion includes a detachable portion of the voucher comprising instructions to the recipient to redeem the gift by entering the gift selection and delivery information on the detachable portion, detaching the portion, and mailing it to an indicated supplier of the selected gifts.

### Method of Making a Promotional Incentive Voucher for Providing a Stored Value Card as a Gift to a Recipient of the Voucher

Another important aspect of the invention is a method of creating a promotional incentive voucher in accordance with the invention. The method includes the following steps:

(a) obtaining advertising information to be included in the advertising portion of the promotional incentive voucher;

(b) obtaining gift selection information comprising a listing of stored value cards (SVCs) to be displayed on the gift display portion of the promotional incentive voucher; and

(c) manufacturing a promotional incentive voucher comprising said advertising and gift selection portions, and a gift redemption portion comprising instructions for obtaining the selected SVC.

The processes of obtaining advertising information from business representatives, and of designing graphics and text to be used in the advertising portion of the promotional incentive voucher are well known to those of skill in the arts of advertising and graphic design, and are essentially the same as those used generally in the field of print advertising. To produce a promotional incentive voucher of the invention, a promotional incentive voucher producer works with a business owner or marketing representative to design the look and feel of the artwork and advertising message and sentiment to be presented on the advertising portion of the promotional incentive voucher.

The selection of available SVCs to be offered on the gift display portion of the voucher is determined by the business representative in consultation with the promotional incentive voucher producer, based on the totality of gift card types available for offer by the producer (which can be essentially unlimited).

Aided by the perception or actual knowledge of the business representative as to which choices are most likely to appeal to customers of the business, a decision is made as to which selection of gift cards is desired by the company. As noted above, any number of SVC choices, (limited only by the practicality of fitting readable choices on the voucher), may be chosen from among the plurality of SVC choices available to the producer of the incentive vouchers.

Having obtained from the business representative the desired information regarding the content of the advertising and gift display portions, and having agreed on the overall design of the promotional incentive voucher (including the method of gift redemption), the promotional incentive voucher producer manufactures a customized promotional incentive voucher for the business bearing the desired graphics and text, using printing and voucher production methods well known in the art. Upon acceptance of proofs of the cards by the business concern, the voucher producer manufactures the vouchers in the desired amounts and arranges for their delivery to the business. As described above, the business distributes the vouchers to its customers and business “leads” as promotional items designed to incentivize new or existing customers to increase their business activities with the donor company.

The process of gift redemption following receipt of a promotional gift card by a customer or target of the donor business is effected in one of several ways, depending upon the redemption instructions provided on the gift redemption portion of the promotional incentive voucher. In one embodiment, as discussed above, the gift redemption portion of the voucher instructs the recipient to visit a website and enter gift selection and delivery information (e.g., the number of the chosen gift SVC and a mailing address for delivery of the selected gift) at an online gift fulfillment center.

In another embodiment, the gift redemption portion of the promotional incentive voucher includes a detachable portion comprising, e.g.,: instructions to the recipient to fill out and physically mail the detachable redemption portion (“redemption card”) to a gift processing center; a gift indication section for indicating the recipient's desired selection among the choices of SVCs; and a delivery address section for indicating the recipient's mailing address for delivery of the gift. Preferably, the detachable gift redemption card is provided with prepaid postage, adding to the convenience (and feeling of goodwill) of the recipient of the incentive voucher.

In some embodiments of the method, the processes involved in fulfilling the orders for the selected SVCs, including gift sourcing, maintaining gift inventory, entering and tracking gift redemption data and shipping of gifts to recipients, are managed internally, i.e., in an all-in-one operation coordinated by the producer of the promotional incentive vouchers.

### Exemplication

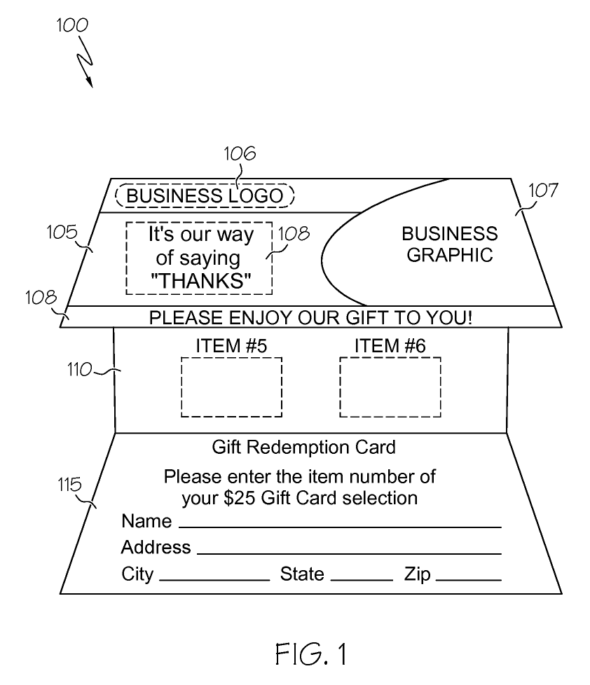

By way of a non-limiting example, FIG. 1 illustrates an exemplary embodiment of a promotional incentive voucher for providing a selectable stored value card (SVC) to a recipient, in accordance with the present invention. Referring to FIG. 1, a promotional incentive voucher 100 comprises a tri-fold construction including an advertising portion 105, a gift display portion 110 and a gift redemption portion 115. The voucher 100 is configured to be foldable into equal thirds.

Each of the portions 105, 110, and 115 comprises a front and a back surface. One preferred embodiment is shown in FIGS. 1 and 2, although many other variations are possible. Referring to FIG. 2, and by comparison with FIG. 1, it can be appreciated that when the promotional incentive voucher 100 is unfolded and laid flat, printed matter comprising the advertising message is printed on the back surface of the portion 105 (not visible in FIG. 2), whereas printed matter comprising the gift display information is printed on the front surfaces of portions 105 and 110. Gift redemption instructions are printed on the front surface of the portion 115. Return mail address information of the gift fulfillment center and optional prepaid postage are printed on the back surface of the portion 115 (not shown).

Referring again to FIG. 1, it will be apparent that the printing is arranged on the front and back surfaces of portions 105, 110 and 115 as described to provide for the incentive voucher 100 to be folded in thirds (e.g., in preparation for mailing to a recipient, and upon removal from an envelope, or, in absence of an envelope, in embodiments secured in the folded state by a fastener as described above). Furthermore, upon such folding, the front surfaces of portions 105, 110 and 115 are positioned on the inside of the card (and hence concealed from view), whereas the printed back surface of portion 105, bearing the advertising information and expression, is on the outside facing the viewer. Accordingly, in the folded configuration, the promotional incentive voucher 100 first presents its advertising and sentiment-expressing face to the recipient.

For purposes of business promotion, the advertising portion 105 is printed with advertising information that can include but is not limited to a business logo or trademark 106, one or more graphic images 107 that can depict, e.g., the business, or, e.g., its contented customers using the products or services of the business.

The advertising portion 105 of the incentive voucher 100 preferably further includes one or more expressions of positive emotions 108 intended to be directed to the recipient of the voucher by the business or its representatives. In the example 100 illustrated in FIG. 1, the expressions 108 include statements of gratitude and good wishes respectively, i.e., “It's our way of saying THANKS” and “PLEASE ENJOY OUR GIFT TO YOU.” The concealment of the gift selection and gift redemption information (which as discussed is printed on the front surfaces of portions 105, 110 and 115 and hence is on the inside of the card when folded), further stimulates feelings of curiosity and delight in the recipient, urging the viewer to open the card to determine the nature of the gift awaiting inside.

Referring further to FIG. 2, there is shown an embodiment of the promotional incentive voucher 100 in its unfolded (open and flattened) state, that illustrates examples of features that can be placed on the printed front surfaces of the gift display portions 105 and 110, and the gift redemption portion 115.

In the embodiment shown, the gift selection portions 105 and 110 of the promotional incentive voucher 100 provide a listing of six possible numbered choices (“items”) for $25 gift cards (SVCs) that are useable at various retail stores. The particular choices of stores 122, 123, 124, 125, 126, and 127 included in the selection depicted on portions 105 and 110 of the voucher 100 (shown stylistically in the drawing) include a toy store, a book store, a sporting goods store, a department store, a sunglass store and a linen and bath store. Representations of the actual stores or services can include graphics, logos, trademarks or other images that are recognizable by consumers. Optionally, the graphics associated with the stores can be accompanied by text providing a brief description of the goods or services available when using a gift card from the selected store.

The gift selection portions 105, 110 of the promotional incentive voucher 100 can also provide instructions to the recipient to select a gift card from the listed SVCs and complete the Gift Redemption Card 115, as shown in FIG. 2.

The gift redemption portion 115 (indicated in FIG. 2 as a “Gift Redemption Card”) of the promotional incentive voucher 100 can be perforated (shown by dotted line 130) to facilitate detachment of the gift redemption portion from the remainder of the incentive voucher 100. Alternatively, the portion 115 can be printed with a dotted line and scissors icon, or similar designation at the position of line 130, with instructions to the recipient to cut the voucher along the line 130.

The gift redemption portion 115 serves to provide printed instructions 129 to the recipient, such as to indicate the item number of the selected gift, and provide an address to which the gift should be mailed, upon fulfillment of the order for the selected gift card.

The back surface of the gift redemption portion 115 (not visible in FIG. 1 or 2) is printed with the address of the gift processing center, and preferably may include a prepaid postage designation.

### Equivalents

The invention has been described in detail with reference to preferred embodiments thereof. Nevertheless, it will be understood upon consideration of the present disclosure that various modifications and improvements may be made without departing from the spirit and scope of the invention.

It is intended, therefore, that the specification and exemplification be considered by way of example only, with a true scope and spirit of the invention being indicated by the following claims and their full scope of equivalents.

What is claimed is:

1. A promotional incentive voucher for providing a selectable stored value card (SVC) as a gift to a recipient, comprising:
(a) an advertising portion comprising information that identifies a business that is providing the incentive voucher and gift to a recipient of the voucher;
(b) a gift display portion comprising a listing of a plurality of SVCs selectable by a recipient of the voucher; and
(c) a gift redemption portion for use by the recipient for indicating a selected SVD from the listing and providing recipient delivery information.

2. The promotional incentive voucher of claim 1, wherein the advertising portion comprises text or graphics that identify the business to the recipient.

3. The promotional incentive voucher of claim 1, wherein the advertising portion comprises a statement of gratitude for using the goods or services of the business.

4. The promotional incentive voucher of claim 1, wherein the gift display portion comprises a listing of SVCs for retail stores or service providers fitting the demographics of the intended recipients of the voucher.

5. The promotional incentive voucher of claim 1, wherein the gift redemption portion comprises a detachable card with instructions to the recipient to redeem the gift by entering gift selection and delivery information on the detachable card and mailing the detached card to a provider of the selected gift.

6. The promotional incentive voucher of claim 1, wherein the gift redemption portion comprises instructions to the recipient to redeem the gift by entering gift selection and delivery information at a website on the internet.

7. The promotional incentive voucher of claim 1, wherein the voucher is foldable, and upon said folding, the advertising portion faces outward and the gift display portion and the gift redemption portions are positioned inside the card.

8. The promotional incentive voucher of claim 7, further comprising an envelope proportioned to contain said card upon folding.

9. The promotional incentive voucher of claim 7, further comprising a removable fastener for maintaining the card in its folded configuration.

10. A method for producing a promotional incentive voucher for providing a selectable stored value card (SVC) as a gift to a recipient, comprising:
(a) obtaining from a business advertising information desired to be included in an advertising portion of the promotional incentive voucher;
(b) obtaining from said business gift selection information comprising a plurality of SVCs to be listed on the gift display portion of the incentive voucher; and
(c) producing a promotional incentive voucher comprising the advertising and gift selection information desired by the business, and a gift redemption portion including instructions to the recipient for obtaining the selected SVC gift.

11. The method of claim 10, wherein the voucher is customized for a business selected from a financial institution, an insurance company, an automobile or marine manufacturer or dealership, a furniture retailer, an electronics retailer or supplier, a utilities provider, a hospital or health services provider, a residential or commercial builder, or an educational institution.

12. The method of claim 10, wherein the gift redemption portion comprises instructions to the recipient to complete and mail a gift redemption portion of the incentive voucher, in order to request delivery of the selected SVC from an order processing center.

13. The method of claim 10, wherein the gift redemption portion comprises instructions to the recipient to provide gift selection and delivery information at a website on the internet in order to request delivery of the selected SVC from an order processing center.

14. The method of claim 12, wherein the order processing center is operated by the producer of the promotional incentive voucher.

15. The method of claim 13, wherein the order processing center is operated by the producer of the promotional incentive voucher.
